(19) United States
(12) Patent Application Publication
(10) Pub. No.: US 2026/0318709 A1
(43) Pub. Date: Oct. 15, 2026

(54) CALIBRATION OF A MULTI-SENSOR FUSION SYSTEM FOR INERTIAL NAVIGATION

(71) Applicants: SAFRAN, Paris (FR); ASSOCIATION POUR LA RECHERCHE ET LE DEVELOPPEMENT DES METHODES ET PROCESSUS, Paris (FR)

(72) Inventors: Colin PARELLIER, MOISSY-CRAMAYEL (FR); Camille Jocelyn Roger CHAPDELAINE, MOISSY-CRAMAYEL (FR); Axel BARRAU, MOISSY-CRAMAYEL (FR); Silvère BONNABEL, Paris (FR)

(73) Assignees: SAFRAN, Paris (FR); ASSOCIATION POUR LA RECHERCHE ET LE DEVELOPPEMENT DES METHODES ET PROCESSUS, Paris (FR)

(21) Appl. No.: 19/481,103

(22) PCT Filed: Apr. 26, 2024
(86) PCT No.: PCT/FR2024/050551

§ 371 Date: Nov. 3, 2025

(30) Foreign Application Priority Data
May 4, 2023 (FR) FR2304486

(51) Int. Cl. G01C 25/00

(52) U.S. Cl. CPC G01C 25/00

(57) ABSTRACT

A navigation assistance method comprising predicting a position of an agent, said prediction comprising: —acquiring a set of measurements (20) linked to the displacement of said agent; and —determining the position by calibrating an extended Kalman filter applied to the set of measurements (20), wherein the calibration comprises a quantification of a divergence with respect to a current distribution of the uncertainties associated with the measurements.

### FIELD OF THE INVENTION

The present invention relates to the estimation of the position of an agent from a previous position and measurements related to its movement and/or position. In particular, it allows for the prediction of the trajectory followed by the agent.

Inferring the navigation or the movement of an agent (pedestrian, vehicle, drone . . . ) can typically be done by using a Kalman filter merging measurements coming for example from an inertial unit embedded or associated with this agent or other sensors such as cameras, Lidar, GPS, odometers (which can measure the speed of the wheels, for example), etc. The Kalman filter allows inferring its position, from its last position and the various measurements, but also potentially its speed, acceleration, etc.

The Kalman filter estimates, during successive iterations, a state of navigation of the agent via matrix, therefore linear, equations using noisy measurements provided by these sensors. It assimilates the measurements to a dynamic system governed by linear equations, which is a binding limitation and does not allow for accurate modeling of the behaviors of the sensors.

The Extended Kalman Filter (EKF) has been proposed to allow taking into account dynamic systems governed by non-linear equations. This method is in particular described in Hargrave P. J., “A tutorialintroduction to Kalman filtering”, IEE colloquium on Kalman filters: introduction, applications and future development, IET, 1989, or even Terejanu Gabriel A, “Extended Kalman filter tutorial”, University of Buffalo, 2008.

The Extended Kalman Filter includes an additional step consisting in linearizing, at each new iteration of the filter, the equations governing the non-linear system at a point in the estimated vector space, typically during a previous iteration. The matrices derived from this linearization can thus be used to estimate a new state according to the method of the classical Kalman filter.

The extended Kalman filtering is commonly used for various measurement fusion problems, for example to merge inertial measurements with GPS, camera, lidar, odometer measurements, etc. Examples include Barrau A, “Non-linear state error based extended Kalman filters with applications to navigation”, doctoral thesis, Mines Paris-tech, 2015, or even Potokar E. R., Norman K, Mangelson J. G. “Invariant extended Kalman filtering for underwater navigation”, IEEE Robotics and Automatic Letters, 6(3), 5792-5799, 2021.

Methods other than the Kalman filters exist to perform measurement fusions and allow the estimation of a future state (trajectory in particular), but they tend to be generally more computationally expensive, which can be problematic for a real-time estimation.

The performance, in terms of accuracy and precision of the estimation, of the (classical or extended) Kalman filter relies for a large part on the calibration of the covariance matrices modeling the uncertainty associated with the different sensors.

We can cite the article Abbeel P. et al., “Discriminative Training of Kalman Filters”, in Robotics: Sciences and systems, vol. 2, p. 1, 2005, which describes several learning algorithms for the covariance parameters for extended Kalman filters from a trajectory history.

It is also possible to dynamically adapt the covariance matrices by a neural network, the latter being trained on the history of the trajectories, as described for example in Brossard M., Barrau A., Bonnabel S., “AI-IMU Dead-Reckoning” in IEEE Transactions on Intelligent Vehicles, 5(4), 585-595, 2020.

However, the optimization of the covariance matrices generally encounters convergence difficulties, in particular because they do not take into account the distribution changes induced by the update of the covariances.

Furthermore, some optimization techniques do not comply with the constraint that the covariance matrices must be necessarily positive.

### SUMMARY OF THE INVENTION

There is therefore a need to improve the current proposals of the state of the art. The invention thus aims in particular to improve the performance of the calibration of a multi-sensor fusion system for the inertial navigation.

Particularly, according to a first aspect, the present invention can be implemented by a navigation assistance method including a prediction of a position of an agent, said prediction including:
the acquisition of a set of measurements related to the movement of said agent,
the determination of said position by calibration of an extended Kalman filter applied to said set of measurements, said calibration comprising a quantification of a divergence with respect to a current distribution of the uncertainties associated with the measurements.

The invention may also retain a navigation assistance method including a prediction of a position of an agent including steps of:
acquiring a set of measurements related to the movement of said agent, and,
determining said position by applying an extended Kalman filter to said set of measurements, said extended Kalman filter being parameterized by at least one covariance matrix determined by optimizing a given optimization criterion by natural gradient descent.

The modification of the covariance matrix allows modifying the modeling of the uncertainties on the measurements. The modification of the modeling of the uncertainties allows modifying the way in which the extended Kalman filter inferring the navigation weights the measurements with respect to the a priori estimated state.

According to preferred embodiments, the invention comprises one or more of the following characteristics which can be used separately or in partial combination with each other or in total combination with each other:
said quantification is used for the calculation of a natural gradient making it possible to update the distribution of the uncertainties.

The natural gradient is a probabilistic gradient that allows quantifying the variation in the distribution of a criterion, regardless of how this distribution is parameterized;
said at least one covariance matrix, R, is factorized in the form R=L·L^{T} where L is a second matrix, and in which the optimization is performed on said at least one second matrix;
said optimization takes place prior to the mission of said agent, such that said at least one covariance matrix is fixed during said mission;
said natural gradient descent is performed on said at least one second matrix;
said natural gradient is expressed by:

$$\tilde{∇} C ( L ) = \frac{1}{2} {LL}^{T} \frac{\partial C}{\partial R} L \qquad [ Math . 1 ]$$

in which

$$\frac{\partial C}{\partial R}$$

represents the Euclidean gradient of said optimization criterion, C, as a function of said at least one covariance matrix, R, and \tilde{∇}C(L) represents said natural gradient.
said optimization takes place during said mission such that said at least one covariance matrix is dynamically adapted as a function of said set of measurements;
said optimization is performed by means of an adaptation module taking said set of measurements as input and whose parameters are determined by said natural gradient descent;
said natural gradient is approximated by the expression:

$$\tilde{∇} C ( θ ) = \frac{1}{2} {LL}^{T} \frac{\partial C}{\partial R} L \frac{\partial L}{\partial θ} \qquad [ Math . 2 ]$$

in which

$$\frac{\partial C}{\partial R}$$

is the Euclidean gradient of said optimization criterion C as a function of said at least one covariance matrix, R,

$$\frac{\partial L}{\partial θ}$$

represents the Euclidean gradient of said at least one second matrix, L, with respect to said parameters, θ, and \tilde{∇}C(O) represents said natural gradient.

Another aspect of the invention relates to a computer program including instructions for implementing a method as previously described.

Another aspect of the invention relates to a device for predicting a position of an agent, comprising a processor adapted for the acquisition of a set of measurements related to the movement of said agent and to implement an extended Kalman filter adapted for the determination of said position from said set of measurements, and a calibration device adapted to parameterize at least one covariance matrix of said extended Kalman filter, determined by optimizing a given optimization criterion by natural gradient descent.

According to preferred embodiments, this device may comprise one or more of the characteristics previously mentioned in relation to the method, which may be used separately or in partial combination with each other or in total combination with each other.

Other characteristics and advantages of the invention will appear upon reading the following description of one preferred embodiment of the invention, given by way of example and with reference to the appended drawings.

### BRIEF DESCRIPTION OF THE FIGURES

The appended drawings illustrate the invention:

FIG. 1 schematically illustrates a high-level functional architecture of a trajectory prediction device.

FIG. 2 schematically represents a high-level functional architecture of a calibration device according to one embodiment.

FIG. 3 schematically represents a high-level functional architecture of a calibration device according to another embodiment.

FIG. 4 schematically represents a high-level functional architecture of an optimization module according to one embodiment.

FIG. 5 illustrates performance examples according to different trajectory prediction methods.

### DETAILED DESCRIPTION OF EMBODIMENTS OF THE INVENTION

According to one embodiment, the described method relates to the inference of the inertial navigation of an agent (pedestrian, vehicle or ground, aerial or marine drone). This agent is typically a mobile carrier, that is to say an individual or a system (vehicle, drone, etc.) carrying or embedding a device allowing the implementation of the proposed method.

Thus, the agent is equipped with one or more inertial measurement units (IMU) as well as, possibly, one or more other sensors such as a positioning sensor (GPS . . . ), an odometer, a camera, a lidar, etc.

The inertial measurement units, or inertial units, are equipment used in navigation and are capable of integrating the motions of a mobile (angular velocity and acceleration) to estimate its orientation (roll, pitch and heading angles), its speed and its position.

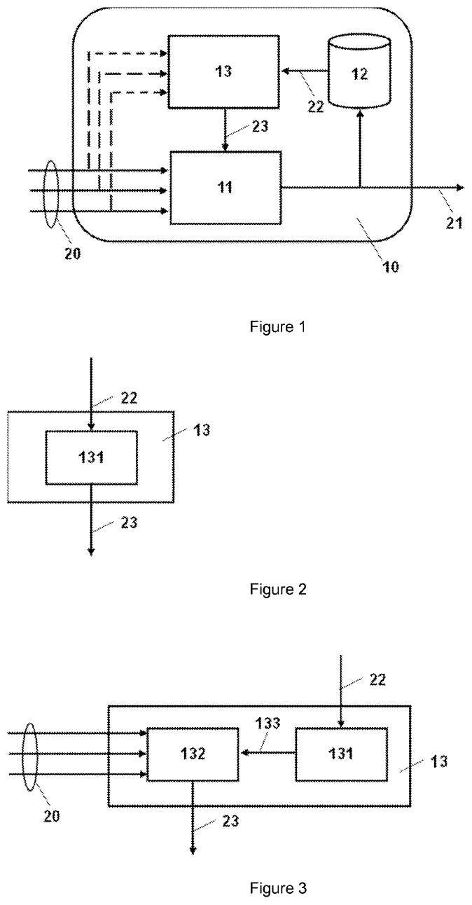

FIG. 1 illustrates a high-level functional architecture of a trajectory prediction device.

This device 10 acquires a set of measurements 20 related to the movement of said agent. Based on a state at an instant (or iteration) t, the prediction device can infer a state 21 at a next instant (or iteration) t+1 as a function of the acquired measurements 20. This state can represent the position of the agent at that next instant or iteration, and thus allow describing the trajectory of the agent iteratively.

In FIG. 1, three arrows representing measurements 20 are represented, but it is of course possible to take into account a different number of input measurements.

The trajectory prediction device 10 includes a multi-sensor fusion system 11, which can for example be an extended Kalman filter.

This extended Kalman filter applied to the set of measurements 20 allows them to be merged to estimate a position of the agent at the next iteration.

The extended Kalman filter 11 is parameterized by the covariance matrices 23 of the uncertainties associated with the different measurements. There is therefore typically one covariance matrix per measurement source that is to say per sensor. These covariance matrices are determined by a calibration device 13.

For this calibration, the device accumulates the trajectory data in a trajectory database 12 (or history of the trajectories). The trajectory data can be retrieved at the output of the Kalman filter as illustrated in FIG. 1, but they can also be accumulated at the input of the filter or at any other moment during the fusion by the filter.

According to another embodiment, the trajectory database 12 is previously constituted and may not need to be enriched by the trajectories estimated by the extended Kalman filter 11. In other words, the history is based on previous movements or missions of the agent or other agents, and does not take into account the behavior of the agent during the current mission.

The trajectory data stored in the database 12 may comprise the measurements acquired by the sensors 20, matrices and vectors calculated by the extended Kalman filter 11 (these matrices and vectors may typically be Jacobian matrices and innovation vectors).

The calibration device 13 determines the covariance matrix(ces) 23 by using trajectory data 22 retrieved from the database 12.

In a first embodiment, the calibration may be performed statically. In this embodiment, the calibration device 13 only takes as input the trajectory data 22 derived from the history 12.

As illustrated in FIG. 2, the calibration device 13 includes an optimization module 131 which takes as input the historical trajectory data 22 and provides an optimized quantity 23. Generally, the optimization block has the role of optimizing a quantity according to a given criterion. In the present case, the optimized quantity is the covariance matrix(ces).

As seen previously, one matrix per measurement can be provided, so that the optimization module can implement an optimization algorithm for each of the acquired measurements 20.

The optimization of the covariance matrices 23 can be performed prior to the navigation phase, for example before the agent leaves on a mission. Once in the mission phase, the matrices remain fixed until the mission is completed or an operator triggers a new matrix calibration phase. This is why, in this embodiment, the calibration of the covariance matrices is referred to as static.

In a second embodiment, the calibration of the covariance matrices of the sensors is carried out dynamically, that is to say by taking into account the set of measurements 20 acquired during the mission.

In other words, the progress of the current mission influences the correlation matrices 23 which allow the Kalman filter to infer a future position 21.

To do so, as illustrated in FIG. 3, the calibration device 13 includes an adaptation module 132 provided to predict the covariance matrices 23 from the set of the acquired measurements 20 and meta-parameters 133 (or parameters) determined by the optimization module 131 from the historical trajectory data 22.

In other words, in this embodiment, the adaptation takes place during the mission of the agent, so that the covariance matrix is dynamically adapted as a function of the set of measurements.

This adaptation module 132 can implement a function therefore making it possible to determine a covariance matrix as a function of these input data.

This function may for example be implemented by a machine learning mechanism. For example, the adaptation module 132 may be a neural network. Particularly, it may be a convolutional neural network (CNN), as described for example in Brossard M., Barrau A., and Bonnabel S. “AI-IMU Dead-reckoning”, cited above.

The set of the acquired measurements 20 is provided to the input layer of this neural network. The latter generates a covariance matrix 23 on its output layer.

In this embodiment, the optimization module 131 may operate similarly to the first embodiment, but instead of optimizing a covariance matrix, it optimizes a set of meta-parameters or parameters of the neural network. These meta-parameters comprise in particular the synaptic weights of the neural network which form the predictive model represented by the neural network.

The calibration device 13 can operate in two phases.

In a first phase, the optimization module 131 determines the parameters 133 of the neural network from the historical trajectory data 22.

This first phase can be implemented prior to the mission, that is to say before the departure of the agent.

Once on a mission, a second phase can be triggered during which the parameters of the neural network 132 are fixed until the mission is completed or an operator has triggered a new parameter optimization phase (using new historical trajectory data collected during the mission).

In this second phase, the calibration device 13 takes as input the set of acquired measurements 20 and dynamically generates the covariance matrices 23, by means of the neural network 132 configured by the parameters 133 set during the first prior phase. Thus, the covariance matrices change as a function of the acquired measurements 20. This is why, in this embodiment, the calibration of the covariance matrices is referred to as dynamic.

Through the phase of optimizing its parameters prior to the mission phase, the neural network 132 has learned to calculate the covariance matrices 22 that allow obtaining the best performance in terms of navigation inference, in the sense of a criterion making it possible to optimize its parameters.

The first embodiment, based on the static calibration, can be used in an environment that changes relatively little, typically for short navigations in a structured environment. Conversely, it is preferable to use the second embodiment, based on the dynamic calibration, when the environment can significantly vary during the navigation, typically for long navigations or in unstructured environments.

Among the causes of variabilities of the environment, mention can be made of the following:
The variation in weather conditions during the navigation can modify the uncertainty associated with some sensors (cameras, in particular);
The geographical environment may present more or fewer points of interest, which modifies the density of the mapping obtained with the Lidar and/or the cameras;
The GPS signal may be degraded depending on the crossed areas.

The calibration device 13 can calibrate a set of covariance matrices 23 that parameterize the extended Kalman filter 11. A covariance matrix can be determined for each measurement of the set of measurements 20 acquired by the trajectory prediction device 10.

The following description relates to a covariance matrix. It is understood that this described method can be repeated for the set of sensors.

R denotes the covariance matrix associated with a given sensor. This covariance matrix can be calibrated as previously described, statically or dynamically.

Since the matrix R is a covariance matrix, it must be symmetrical and positive.

In order to ensure the positivity and symmetry of this covariance matrix, the matrix R is factorized so that R=L·L^{T}, where the symbol ^{T} indicates the matrix transposition.

This factorization can for example be performed by Cholesky factorization, but other methods are available in the state of the art. In the case of Cholesky factorization, this matrix L is a lower triangular matrix, but the method described is more general and can be applied without imposing such a constraint on the matrix L.

In the static embodiment, illustrated in FIG. 2, the optimization module 131 determines, by optimization, the matrix L. The calibration device 13 can then directly determine and provide the covariance matrix R by R=L·L^{T} to the extended Kalman filter 11.

In the dynamic embodiment, illustrated in FIG. 3, the optimization module 131 determines the parameters 133, denoted θ, of the neural network 132. This neural network then provides, in the mission phase, the matrix L(x, θ), where x represents the acquired measurements. The calibration device 13 can then directly determine and provide the covariance matrix R by R=L(x, θ)·L(x, θ)^{T} to the extended Kalman filter 11.

The optimization module 131 therefore aims to optimize a matrix L as a function of a certain criterion C.

This criterion can be any criterion.

This could for example be a likelihood of the matrix L, particularly a log-likelihood, as described for example in the article by Abbeel P. et al, “Discriminative Training of Kalman Filters” cited above.

However, the proposed method can be based on different criteria, it does not depend on the criterion to be optimized as such.

The optimization of the criterion C can be performed by a classic gradient descent method.

The gradient algorithm, also called gradient descent algorithm, designates an iterative optimization algorithm where, at each iteration, it is sought to improve the current solution by moving in a direction opposite to the gradient so as to decrease the criterion to be minimized. The gradient algorithm is also known as the steepest slope or steepest descent algorithm because the gradient is the slope of the linearized function at the current point and is therefore, locally, its steepest slope (a notion that depends on the scalar product).

The gradient descent algorithm is extensively described in the scientific literature. The corresponding Wikipedia page can be consulted as an example and entry point:
https://fr.wikipedia.org/wiki/Algorithme_du_gradient
https://en.wikipedia.org/wiki/Gradient_descent

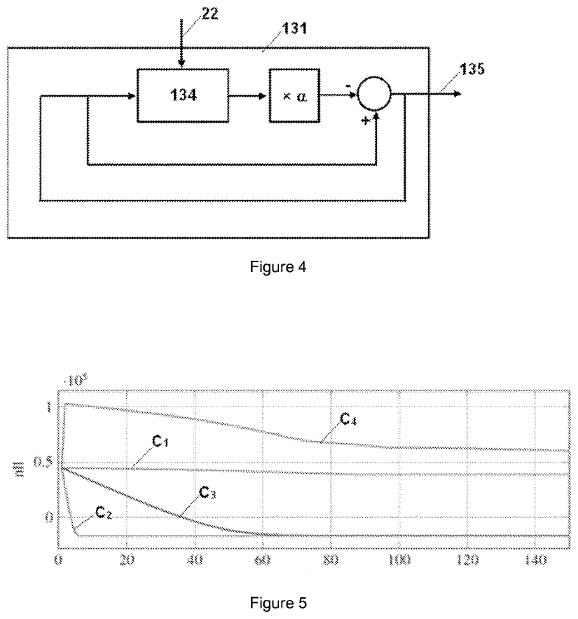

FIG. 4 illustrates a functional view of the optimization module 131.

The optimization module 131 takes as input the historical trajectory data 22, from which a module 134 calculates a gradient \tilde{∇}C(V), C being the criterion to be minimized, and V being a quantity whose value minimizing this criterion C is sought. This value V is referenced 135 in FIG. 4 and it can be the matrix L or the parameters θ of the neural network 132.

Thus, in a static embodiment where it is sought to optimize the matrix L, the optimization module 135 iteratively operates the natural gradient descent:

L←L−α\tilde{∇}C(L) [Math. 3]

In a dynamic embodiment, where it is sought to optimize the parameters θ, 133, of the neural network, the optimization module 135 iteratively operates the natural gradient descent:

θ←θ−α\tilde{∇}C(θ) [Math. 4]

These operations (according to the embodiments) are repeated as indicated in FIG. 4. Thus, following the calculation of the gradient \tilde{∇}C(V) by the functional block 134 (V designating L or θ depending on whether it is the static or the dynamic embodiment), this gradient is multiplied by a descent step α. This descent step is a parameter that can be set beforehand. The circle in the figure illustrates the operation V−α\tilde{∇}C(V), whose result provides a new value of the quantity V at the following iteration. This new value is reintroduced at the input of the gradient calculation block 134 in order to provide a new iteration.

Classically, this iterative process ends when an optimization criterion is reached, that is to say when the criterion reaches a determined threshold or when the gradient no longer evolves sufficiently (\tilde{∇}C(V) is lower than another threshold), or when a sufficient number of iterations have been performed, etc.

The gradient \tilde{∇}C(V) could be calculated by using a Euclidean gradient. This Euclidean gradient can be written as

$$\frac{\partial C}{\partial V}$$

or:
in the static mode:

$$\frac{\partial C}{\partial L} .$$

in the dynamic mode:

$$\frac{\partial C}{\partial θ}$$

However, this Euclidean gradient does not allow taking into account the change of distribution induced by the update of the sensor covariance matrix.

This leads to difficulties in the convergence of the gradient descent, and to a difficult adjustment of the descent step α.

Strategies have been proposed to improve the gradient descent, such as the “Adam” mechanism for the neural networks. This mechanism is described in particular in the seminal article: Kingma, D. P., BA. J, “Adam: A method for stochastic optimization”, 2014, arXiv:1412.6980.

However, these mechanisms do not allow solving all the problems and, in particular, the adjustment of the descent step α remains tricky.

It is proposed to perform a gradient descent based on the natural gradient, instead of the Euclidean gradient.

The natural gradient descent allows taking into account the distribution change induced by the change in the covariance R=L·L^{T}. In particular, it allows taking into account that the parameter space in which the optimization is sought is not necessarily a Euclidean space but, more generally, a Riemann space.

The natural gradient and its use for the optimization of a criterion C by gradient descent is described in particular in the article by Amari S., “Natural Gradient Works Efficiently in Learning”, Neural Computation, 10(2), 251-276, 1998, or in the article Amari, Shun'ichi (1983). “A foundation of information geometry”. Electronics and Communications in Japan. 66 (6): 1-10. doi:10.1002/ecja.4400660602.

The natural gradient allows quantifying the divergence (that is to say a non-symmetric distance, such as the Kullback-Leibler divergence) with respect to the current distribution of the uncertainties associated with the sensor, when an infinitesimal variation is applied to the considered quantity (the matrix L or the parameters θ of the neural network).

To calculate the natural gradient with respect to V, parameterizing a probability distribution p(.|V) (typically, a centered Gaussian law parameterized by its covariance matrix), the Kullback-Leibler divergence between the law p(.|V) and p(.|V+δV) is calculated, where SV corresponds to a variation of V: this divergence is denoted:

KL(p(.|V+δV)∥p(.|V)) [Math. 5]

The development limited to the second order of this divergence allows revealing a scalar product

$${〈 δ V \vert δ V 〉}_{V} :$$

$$K L ( p ( . \vert V + δ V ) \vert \vert p ( . \vert V ) ) \approx \frac{1}{2} {〈 δ V \vert δ V 〉}_{V} \qquad [ Math . 6 ]$$

The scalar product

$${〈 δ V \vert δ V 〉}_{V}$$

is the Fisher information metric (FIM). It is this scalar product that allows calculating the natural gradient: it is noted, between δV and δV′ by:

$${〈 δ V \vert δ {V}^{′} 〉}_{V} .$$

Considering a cost function C(V), the natural gradient \tilde{∇}C(V) of C with respect to V is then identified by revealing the scalar product

$${〈 . \vert . 〉}_{V}$$

in the development limited to the first order of C(V+δW):

$${C ( V + δ V ) \approx C ( V ) + ( \tilde{∇} C ( V ) \vert δ V \}}_{V} \qquad [ Math . 7 ]$$

The difficulty inherent with the natural gradient descent method is the difficulty in determining its expression, and in particular in determining the Fischer information matrix.

Particularly, in the present case, one difficulty is to determine the expression of the natural gradient with respect to the matrix L or with respect to the parameters of the neural network.

It is proposed to determine the natural gradient as a function of a quantity

$$\frac{1}{2} {LL}^{T} \frac{\partial C}{\partial R} L$$

in which

$$\frac{\partial C}{\partial R}$$

is the Euclidean gradient of the optimization criterion C as a function of the at least one covariance matrix R.

Particularly, in the static embodiment, it is proposed to express the natural gradient \tilde{∇}C(L) by the expression:

$$\tilde{∇} C ( L ) = \frac{1}{2} {LL}^{T} \frac{\partial C}{\partial R} L \qquad [ Math . 8 ]$$

$$\frac{\partial C}{\partial R}$$

is the Euclidean gradient of the criterion C to be minimized with respect to the covariance matrix R.

In the dynamic embodiment, the natural gradient of the criterion C with respect to the parameters θ of the neural network are difficult to calculate analytically, because the expression of the neural network L(θ) is complex to manipulate to perform calculations.

The Euclidean gradient

$$\frac{\partial C}{\partial θ}$$

can be decomposed by using the chain rule:

$$\frac{\partial C}{\partial θ} = \frac{\partial C}{\partial L} \cdot \frac{\partial L}{\partial θ} \qquad [ Math . 9 ]$$

$$\frac{\partial L}{\partial θ}$$

is the Euclidean gradient of the matrix L with respect to the parameters θ of the neural network. This gradient is calculated automatically by the back-algorithm in the neural network 132. It is thus directly accessible and usable.

To approximate the natural gradient, the gradient \tilde{∇}C(O) can be set by replacing the term

$$\frac{\partial C}{\partial L}$$

with the expression of \tilde{∇}C(L) given above for the static embodiment.

An approximate expression of the natural gradient for the dynamic case is thus obtained:

$$\tilde{∇} C ( θ ) = \tilde{∇} C ( L ) \frac{\partial L}{\partial θ} = \frac{1}{2} L {L}^{T} \frac{\partial C}{\partial R} L \frac{\partial L}{\partial θ} \qquad [ Math . 10 ]$$

This expression also makes the natural gradient depend on the magnitude

$$\frac{1}{2} L {L}^{T} \frac{\partial C}{\partial R} L$$

FIG. 5 illustrates the convergence performance of the method for the static mode (covariance matrix R fixed throughout the mission).

The figure shows 4 situations of evolution of the criterion C, evaluated by its negative log-likelihood on the abscissa, as a function of a number of iterations.

The curve C₁ shows the progressive minimization of the criterion C with respect to the matrix L by a Euclidean gradient descent

$$\frac{\partial C}{\partial L} .$$

The curve C₂ shows the progressive minimization of the criterion C with respect to the matrix L by a natural gradient descent \tilde{∇}C(L).

It is seen that the curve C₂ descends lower than the curve C₁, which indicates a better minimization of the criterion by the natural gradient descent.

The curves C₃, C₄ illustrate the progressive minimization of the criterion C with respect to the covariance matrix R, respectively by a natural gradient descent and by a Euclidean gradient descent. It is noted here again that the curve C₃ descends lower than the curve C₄, which reflects a better minimization of the criterion C using a natural gradient.

The proposed method differs from the state of the art, firstly, by the use of a natural gradient in the gradient descent mechanism, instead of the gradient.

As described above, this natural gradient descent can be used in a static embodiment to directly obtain a matrix L that allows obtaining the covariance matrix R for the Kalman filter, and in a dynamic embodiment, to obtain parameters of a neural network that allows obtaining this covariance matrix.

The method also proposes to decompose this covariance matrix R into a product L·L^{T} and to perform the optimization on this matrix L, in order to thus guarantee the positivity of the covariance matrix R.

According to another embodiment, the optimization can be performed directly on the covariance matrix R, both in static and dynamic mode.

In order to meet the requirement of positivity of the covariance matrix R, a monitoring mechanism can be implemented. Particularly, a monitoring mechanism on the eigenvalues can be set up, but this increases the calculation time. In this case, the following formulas are proposed:

In static mode:

R←R−α\tilde{∇}C(R) [Math. 11]

With \tilde{∇}C(R) set to the natural gradient of the criterion C with respect to the covariance matrix R, such that:

$$\tilde{∇} C ( R ) = R \frac{\partial C}{\partial R} R \qquad [ Math . 12 ]$$

where

$$\frac{\partial C}{\partial R}$$

is the Euclidean gradient of C with respect to the covariance matrix R.

In dynamic mode, the covariance matrix R=R(x;θ) can be given by a neural network with parameters θ. These parameters are optimized according to a natural gradient descent, as indicated previously:

θ←θ−α\tilde{∇}C(θ) [Math. 13]

As seen previously, \tilde{∇}C(B) can be an approximation of the natural gradient.

Using the same approach as previously, it is indeed possible to replace the term

$$\frac{\partial C}{\partial L}$$

of the expression of the natural gradient with the expression of \tilde{∇}C(L) given above for the static embodiment. An approximate expression of the natural gradient for the dynamic case is thus obtained:

$$\tilde{∇} C ( θ ) = \tilde{∇} C ( R ) \frac{\partial R}{\partial θ} = R \frac{\partial C}{\partial R} R \frac{\partial R}{\partial θ} \qquad [ Math . 14 ]$$

The method therefore also proposes original expressions of the natural gradient, according to different embodiments, in the present case of the optimization of a covariance matrix for Kalman filter. Furthermore, in the dynamic case, an approximation of this natural gradient is proposed.

Of course, the present invention is not limited to the examples and embodiment described and represented, but is defined by the claims. It is in particular susceptible of numerous variants accessible to those skilled in the art.

1. A navigation assistance method including a prediction of a position of an agent, said prediction including:
acquisition of a set of measurements (20) related to the movement of said agent;
determination of said position by calibration of an extended Kalman filter applied to said set of measurements (20), said calibration comprising a quantification of a divergence with respect to a current distribution of the uncertainties associated with the measurements;
wherein said extended Kalman filter is parameterized by at least one covariance matrix determined by optimizing a given optimization criterion by natural gradient descent,
said at least one covariance matrix, R, is factorized in the form R=L·L^{T} where L is a second matrix, and wherein the optimization is performed on said at least one second matrix, and
wherein said natural gradient is determined as a function of a quantity
$$\frac{1}{2} L {L}^{T} \frac{\partial C}{\partial R} L$$
wherein
$$\frac{\partial C}{\partial R}$$
is the Euclidean gradient of said optimization criterion C as a function of said at least one covariance matrix, R.

2. The method according to claim 1, wherein said quantification is used for the calculation of a natural gradient making it possible to update the distribution of the uncertainties.

3. The method according to claim 2, wherein said optimization takes place prior to the mission of said agent, such that said at least one covariance matrix is fixed during said mission.

4. The method according to claim 3, wherein said natural gradient descent is performed on said at least one second matrix.

5. The method according to claim 4, wherein said natural gradient is expressed by:
$$\tilde{∇} C ( L ) = \frac{1}{2} L {L}^{T} \frac{\partial C}{\partial R} L$$
wherein \tilde{∇}C(L) represents said natural gradient.

6. The method according to claim 1, wherein said optimization takes place during said mission such that said at least one covariance matrix is dynamically adapted as a function of said set of measurements (20).

7. The method according to claim 6, wherein said optimization is performed by means of an adaptation module (132) taking said set of measurements (20) as input and whose parameters are determined by said natural gradient descent.

8. The method according to claim 7, wherein said natural gradient is approximated by the expression:
$$\tilde{∇} C ( θ ) = \frac{1}{2} L {L}^{T} \frac{\partial C}{\partial R} L \frac{\partial L}{\partial θ}$$
wherein
$$\frac{\partial L}{\partial θ}$$
represents the Euclidean gradient of said at least one second matrix, L, with respect to said parameters, θ, and \tilde{∇}C(B) represents said natural gradient.

9. A non-transitory storage medium readable by a computer program including instructions for implementing a method according to claim 1.

10. A device (10) for predicting a position of an agent, comprising a processor adapted for the acquisition of a set of measurements (20) related to the movement of said agent and to implement an extended Kalman filter (11) adapted for determining said position by calibration of an extended Kalman filter applied to said set of measurements (20), said calibration comprising a quantification of a divergence with respect to a current distribution of the uncertainties associated with the measurements.
wherein said extended Kalman filter is parameterized by at least one covariance matrix determined by optimizing a given optimization criterion by natural gradient descent, said at least one covariance matrix, R, is factorized in the form R=L·L^{T} where L is a second matrix, and wherein the optimization is performed on said at least one second matrix, and
wherein said natural gradient is determined as a function of a quantity
$$\frac{1}{2} L {L}^{T} \frac{\partial C}{\partial R} L$$
wherein
$$\frac{\partial C}{\partial R}$$
is the Euclidean gradient of said optimization criterion C as a function of said at least one covariance matrix, R.
